(19) United States
(12) Patent Application Publication
(10) Pub. No.: US 2006/0259295 A1
(43) Pub. Date: Nov. 16, 2006

(54) Language interface and apparatus therefor

(75) Inventor: Richard Ellenson, New York, NY (US)

Correspondence Address: GREENBERG-TRAURIG, 1750 TYSONS BOULEVARD, 12TH FLOOR, MCLEAN, VA, 22102, US

(73) Assignee: BlinkTwice, LLC, New York, NY (US)

(21) Appl. No.: 11/324,777

(22) Filed: Jan. 4, 2006

Related U.S. Application Data
(60) Provisional application No. 60/679,966, filed on May 12, 2005.

(51) Int. Cl. G06F 17/21

(52) U.S. Cl. 704/10

(57) ABSTRACT

A method of organizing linguistic elements, comprising creating a plurality of talk topics, wherein each talk topic relates to a particular subject; defining a first set of linguistic element categories, each of the linguistic element categories representing a communicative intent; providing an association between the first set of linguistic element categories and a first one of the plurality of talk topics; providing an association between a first plurality of linguistic elements and one of the first set of linguistic element categories; defining a second set of linguistic element categories, each of the linguistic element categories representing a communicative intent; providing an association between the second set of linguistic element categories and a second one of the plurality of talk topics; and providing an association between a second plurality of linguistic elements and the second set of linguistic element categories.

### PRIORITY CLAIM

The present invention is related to, and claims priority from, Provisional U.S. Patent Application Ser. No. 60/679,966 filed May 12, 2005, the entire disclosure of which, including all appendices, is incorporated herein by reference in its entirety.

### FIELD OF THE INVENTION

The present invention relates to the field of language interfaces, and more specifically provides a hierarchical interface to a language.

### BACKGROUND OF THE INVENTION

There are a variety of reasons why a person may be communicatively challenged. By way of example, without intending to limit the present invention, a person may have a medical condition that inhibits speech, or a person may not be familiar with a particular language.

Prior attempts at assisting communicatively challenged people have typically revolved around creating new structures through which complex communications, such as communications with a physician or other healthcare provider, or full, compound sentences, can be conveyed. For example, U.S. Pat. Nos. 5,317,671 and 4,661,916 to Baker et al., disclose a polysemic linguistic system that uses a keyboard from which the user selects a combination of entries to produce synthetic plural word messages, including a plurality of sentences. Through such a keyboard, a plurality of sentences can be generated as a function of each polysemic symbol in combination with other symbols which modify the theme of the sentence. Such a system requires extensive training, and the user must mentally translate the word, feeling, or concept they are trying to convey from their native language, such as English, into the polysemic language. The user's polysemic language entries are then translated back to English. Such “round-trip” language conversions are typically inefficient and are prone to poor translations.

Others, such as U.S. Pat. No. 5,169,342 to Steel et al., use an icon-based language-oriented system in which the user constructs phrases for communication by iteratively employing an appropriate cursor tool to interact with an access window and dragging a language-based icon from the access window to a phrase window. The system presents different icons based on syntactic and paradigmatic rules. To access paradigmatic alternative icons, the user must click and drag a box around a particular verb-associated icon. A list of paradigmatically-related, alternative icons is then presented to the user. Such interactions require physical dexterity, which may be lacking in some communicatively challenged individuals. Furthermore, the imposition of syntactic rules can make it more difficult for the user to convey a desired concept because such rules may require the addition of superfluous words or phrases to gain access to a desired word or phrase.

While many in the prior art have attempted to facilitate communication by creating new communication structures, others have approached the problem from different perspectives. For example, U.S. Patent Application Publication No. 2005/0089823 to Stillman, discloses a device for facilitating communication between a physician and a patient wherein at least one user points to pictograms on the device. Still others, such as U.S. Pat. No. 6,289,301 to Higginbotham, disclose the use of a subject-oriented phrase database which is searched based on the context of the communication. These systems, however, require extensive user interaction before a phrase can be generated. The time required to generate such a phrase can make it difficult for a communicatively challenged person to engage in a conversation.

### SUMMARY OF THE INVENTION

Accordingly, the present invention is directed to methods for organizing elements of a language, referred to herein as linguistic elements, to facilitate communication by communicatively challenged persons which substantially obviate one or more of the problems due to limitations and disadvantages of the related art. As used herein, the term linguistic element is intended to include individual alphanumeric characters, words, phrases, and sentences.

An aspect of the present invention is directed to a method of organizing linguistic elements comprising creating a plurality of talk topics, wherein each talk topic relates to a particular subject; defining a first set of linguistic element categories, each of the linguistic element categories representing a communicative intent; providing an association between the first set of linguistic element categories and a first one of the plurality of talk topics; providing an association between a first plurality of linguistic elements and one of the first set of linguistic element categories; defining a second set of linguistic element categories, each of the linguistic element categories representing a communicative intent; providing an association between the second set of linguistic element categories and a second one of the plurality of talk topics; and providing an association between a second plurality of linguistic elements and the second set of linguistic element categories.

The linguistic element category sets preferably include at least one linguistic element category corresponding to communicating about something the user wants or does not want to do; at least one linguistic element category corresponding to communicating about things or information; at least one linguistic element category corresponding to communicating something positive; at least one linguistic element category corresponding to communicating something negative; and at least one linguistic element category corresponding to asking a question. The linguistic element category sets can also include at least one linguistic element category corresponding to telling a story or providing instructions.

It is presently preferred that the linguistic element categories be the same across all talk topics, thereby providing a consistent and easily learned user interface to the linguistic elements. While the same linguistic element categories may be used across all talk topics, the linguistic elements associated with the linguistic element categories preferably vary depending on the talk topic. This allows the user to be presented with a narrowly tailored set of environmentally-appropriate or situation-appropriate linguistic elements. Although the set of linguistic elements within each talk topic may be unique, it should be apparent to one skilled in the art that some linguistic elements may be shared among talk topics, and may be categorized under different linguistic element categories depending on the talk topic.

In one embodiment, as the user selects linguistic elements the linguistic elements are added to an editable buffer. The user can then trigger the communication of the elements stored in the buffer. Such communication may include, but is not limited to, computer generated speech based on the language buffer content, playback of audio and/or video content associated with each linguistic element stored in the language buffer, and adding the language buffer content to an E-mail, instant message (IM), or other electronic communication.

Another aspect of the present invention includes a method of organizing linguistic elements comprising creating a plurality of talk topics, wherein each talk topic relates to a particular subject; defining a first set of linguistic element categories, each of the linguistic element categories representing a communicative intent; providing an association between the first set of linguistic element categories and a first one of the plurality of talk topics; and providing an association between a first plurality of linguistic elements and one of the first set of linguistic element categories. In one embodiment, this method can be augmented by defining a second plurality of linguistic elements; providing an association between the second plurality of linguistic elements and the first set of linguistic element categories; and providing an association between the second plurality of linguistic elements and a second one of the plurality of talk topics. Although the first and second plurality of linguistic elements are likely to share common linguistic elements, it should be apparent to one skilled in the art that the first plurality of linguistic elements and the second plurality of linguistic elements need not comprise common linguistic elements. Similarly, although a talk topic may have only a single set of linguistic element categories associated therewith, it should be apparent to one skilled in the art that a plurality of linguistic element category sets can be associated with a talk topic.

Still another aspect of the present invention includes a method of organizing linguistic elements comprising creating a plurality of talk topics, wherein each talk topic relates to a subject; associating a plurality of linguistic elements with each of the plurality of talk topics, wherein the linguistic elements associated with each talk topic are related to the communicative needs of the associated talk topic; and organizing the plurality of linguistic elements into linguistic element categories, wherein each of the plurality of linguistic element categories represents a communicative intent.

Yet another aspect of the present invention includes a method of organizing linguistic elements for display in a user interface comprising defining a maximum number of user interface elements to be concurrently displayed in a user interface; defining a set of talk topics, wherein each talk topic relates to a particular subject; associating a plurality of linguistic elements with each of the plurality of talk topics, wherein the linguistic elements associated with each talk topic are related to the subject of the associated talk topic; defining a set of linguistic element categories, wherein each of the plurality of linguistic element categories represents a communicative intent; assigning each of the linguistic element categories a display position in the user interface; associating at least one linguistic element with at least one linguistic element category; and, ordering the linguistic elements associated with each linguistic element category such that the most frequently used linguistic element within each linguistic element category is in the same display position in the user interface as the linguistic element category with which it is associated.

Still another aspect of the invention includes a method of communicating comprising selecting a talk topic from a plurality of available talk topics, wherein each talk topic is associated with a set of linguistic element categories; selecting a linguistic element category from the set of linguistic element categories associated with the selected talk topic, wherein each linguistic element category represents a communicative intent and is associated with a set of linguistic elements; selecting a linguistic element from the set of linguistic elements associated with the selected linguistic element category; and, communicating the selected linguistic element.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a schematic block diagram of a hardware architecture supporting the methods of the present invention.

FIG. 2 provides front and top views of an embodiment of an apparatus on which the method of the present invention can be implemented.

FIG. 3 illustrates an alternative embodiment of the apparatus of FIG. 2, wherein the apparatus is in customization mode.

FIG. 4 is a top view of an embodiment of the apparatus of FIG. 2, wherein the apparatus is in talk topic selection mode.

FIG. 5 is a top view of an embodiment of the apparatus of FIG. 2, wherein the talk topic corresponding to a group talk communicative intent has been selected.

FIG. 6 is a top view of an alternative embodiment of an apparatus on which the present invention can be implemented, wherein the apparatus is in linguistic element selection mode.

FIG. 7 is a top view of the embodiment of FIG. 6, wherein the Yakkity Yakk talk topic has been selected.

FIG. 8 is a top view of the embodiment of FIG. 6, wherein spelling has been activated.

FIG. 9 is a top view of the embodiment of FIG. 8, wherein individual letters can be selected.

FIG. 10 is a top view of the embodiment of FIG. 6, wherein a desired fringe word category can be selected.

FIG. 11 is a top view of the embodiment of FIG. 10, wherein a desired fringe word can be selected.

FIG. 12 is a top view of the embodiment of FIG. 6, wherein a desired core word category can be selected.

FIG. 13 is a top view of the embodiment of FIG. 12, wherein a desired core word can be selected.

FIG. 14 is a top view of the embodiment if FIG. 6, wherein a desired inflection can be selected.

### DETAILED DESCRIPTION OF THE PREFERRED EMBODIMENT

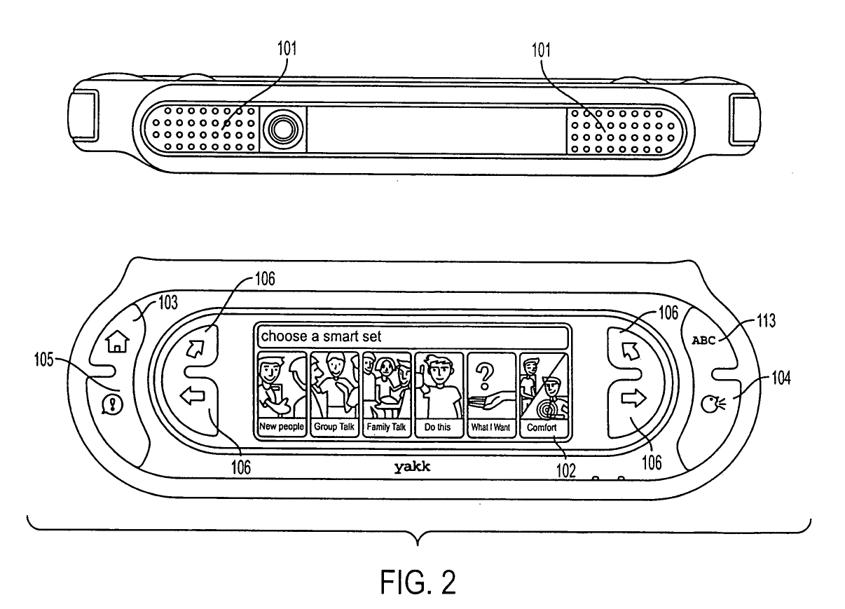

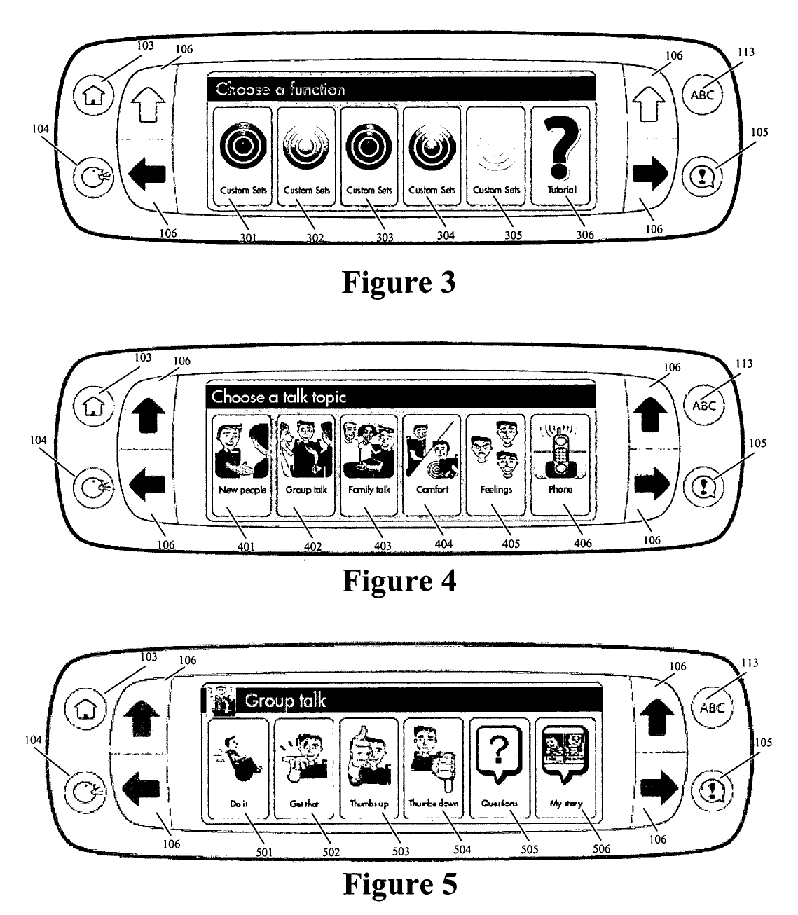

Reference will now be made in detail to embodiments of a language interface, examples of which are illustrated in the accompanying drawings. While the embodiments described herein are based on an implementation of the language interface as part of a specialized, portable computing device such as that illustrated in FIG. 2, it should be apparent to one skilled in the art that the hierarchical language interface can be implemented on any computing device, including, without limitation, a standard desktop computer, a laptop computer, a portable digital assistant (“PDA”), or the like. FIGS. 3-5 illustrate such embodiments. In FIGS. 3-5, the apparatus and the individual user interface components are rendered on a computer display.

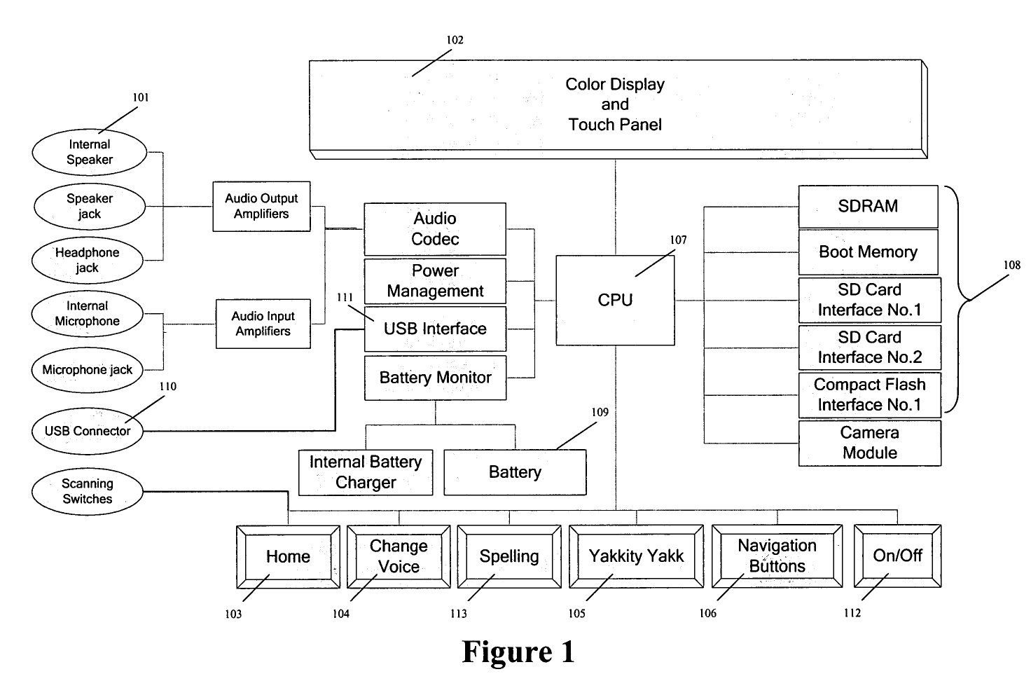

FIG. 1 is a schematic diagram of an embodiment of the invention as implemented on a portable computing device. Such a device preferably includes a central processing unit (“CPU”) 107, at least one storage device 108, a display 102, and a speaker 101. An embodiment of the device may also include physical buttons, including, without limitation, home 103, voice change 104, Yakkity Yakk 105, navigation buttons 106, and power button 112.

As will be apparent to one skilled in the art, in the embodiment illustrated in FIG. 1, CPU 107 performs the majority of data processing and interface management for the device. By way of example, CPU 107 can load the home view, talk topics, linguistic element categories, and linguist elements (described below) as needed, generate information needed by display 102, and monitor buttons 103-106 for user input Where display 102 is a touch-sensitive display, CPU 107 can also receive input from the user via display 102.

In the embodiment illustrated in FIG. 1, the language interface is implemented as computer program product code which is tailored to run under the Windows CE operating system published by Microsoft Corporation of Redmond, Wash. The operating system and related files can be stored in one of storage devices 108. Such storage devices may include, but are not limited to, hard disk drives, solid state storage media, optical storage media, or the like. Although a device based on the Windows CE operating system is described herein, it should be apparent to one skilled in the art that alternative operating systems, including, without limitation, DOS, Linux® (Linux is a registered trademark of Linus Torvalds), Macintosh OSX, Windows, Windows XP Embedded, BeOS, the PALM operating system, or a custom-written operating system, can be substituted therefor without departing from the spirit or the scope of the invention.

The device preferably includes a Universal Serial Bus (“USB”) connector 110 and USB Interface 111 that allows CPU 107 to communicate with external devices. A CompactFlash, PCMCIA, or other adaptor may also be included to provide interfaces to external devices. Such external devices can allow user-selected linguistic elements to be added to an E-mail, IM, or the like, allow CPU 107 to control the external devices, and allow CPU 107 to receive instructions or other communications from such external devices. Such external devices may include other computing devices, such as, without limitation, the user's desktop computer; peripheral devices, such as printers, scanners, or the like; wired and/or wireless communication devices, such as cellular telephones or IEEE 802.11-based devices; additional user interface devices, such as biofeedback sensors, eye position monitors, joysticks, keyboards, sensory stimulation devices (e.g., tactile and/or olfactory stimulators), or the like; external display adapters; or other external devices. Although a USB interface is presently preferred, it should be apparent to one skilled in the art that alternative wired and/or wireless interfaces, including, without limitation, FireWire, serial, Bluetooth, and parallel interfaces, may be substituted therefor without departing from the spirit or the scope of the invention.

USB Connector 110 and USB Interface 111 can also allow the device to “synchronize” with a desktop computer. Such synchronization can include, but is not limited to, copying one or more linguistic element databases; copying media elements such as photographs, sounds, videos, or multimedia files; and copying E-mail, schedule, task, and other such information to or from the device. The synchronization process also allows the data present in the device to be archived to a desktop computer or other computing device, and allows new versions of the user interface software, or other software, to be installed on the device.

In addition to receiving information via USB Connector 110 and USB interface 111, the device can also receive information via one or more removable memory devices that operate as part of storage devices 108. Such removable memory devices include, but are not limited to, Compact Flash cards, Memory Sticks, SD and/or XD cards, and MMC cards. The use of such removable memory devices allows the storage capabilities of the device to be easily enhanced, and provides an alternative method by which information may be transferred between the device and a user's desktop computer or other computing devices.

An embodiment of the invention is designed to allow communicatively challenged individuals to quickly and easily cause the device to “speak” linguistic elements. Such speech may be facilitated by sound recordings of the linguistic element, by voice synthesis software, or the like.

To use the device, the user selects a desired linguistic element by first selecting a “Talk Topic” from a plurality of available talk topics, wherein each Talk Topic represents an environment or talk mode. By way of example, without intending to limit the present invention, such talk topics may include “group talk”, “family talk”, “school talk”, “new people”, and “Comfort”. Each talk topic is preferably presented as a set of buttons or icons on a user interface. The user is then able to select from a plurality of available linguistic element categories. In a preferred embodiment, the linguistic element categories represent a communicative intent, such as something the user wants to do, things or information, expressing something positive, expressing something negative, asking a question, telling a story, conveying an instruction, or the like. When the user has selected a desired linguistic element category, the user is then presented with a set of appropriate linguistic elements. Through this hierarchical structure, the user can easily access situation-appropriate linguistic elements without having to wade through irrelevant linguistic elements.

If a desired linguistic element is not available, the user can press Spelling button 113, which causes a keyboard to be displayed in display 102. The user can then type in the desired linguistic element.

FIG. 2 provides front and top views of an embodiment of the invention implemented as part of a portable device. As FIG. 2 illustrates, the top of this embodiment includes a display 102, navigation buttons 106, Yakkity Yakk button 105, voice change 104, and home button 103. Speakers 101 are preferably provided on the front of the device. In one embodiment, navigation buttons 106 may be backlit, with the backlighting selectively turned on or off depending on whether associated functionality is appropriate at a given time.

Yakkity Yakk 105 provides the user with effectively instantaneous access to a list of frequently used linguistic element categories and linguistic elements, regardless of any other functionality the user is accessing in the device. The Yakkity Yakk functionality preferably allows the user to quickly and easily engage in traditional conversations with others, while at the same time permitting the user to compose more complex thoughts or sentences in the background or use other functionality present in the device. In one embodiment, pressing Yakkity Yakk 105 causes the device to load a special talk topic without the user having to navigate to a new talk topic. An embodiment of the language interface displaying linguistic element categories associated with the Yakkitty Yakk talk topic is illustrated in FIG. 7. By way of example, without intending to limit the present invention, activating the Yakkitty Yakk button may allow the user to access linguistic element categories such as Yes/No 701, Hi and Bye 702, Questions 703, Hints 704, Colors 705, and Help 706. Similarly, once the user has communicated the desired linguistic element within the Yakkity Yakk talk topic, the device preferably returns to the previous talk topic, rather than staying within the Yakkity Yakk talk topic. The use of Yakkity Yakk 105 preferably does not clear any linguistic element buffers (described below) that may be in use.

In the embodiment illustrated in FIG. 1, the talk topics, linguistic element categories, and individual linguistic elements, and the interrelationships thereof, can be stored in storage devices 108, along with one or more media elements associated with the linguistic elements.

In one embodiment, the relationship between the talk topics, linguistic element categories, and linguistic elements is stored in one or more databases. By way of example, without intending to limit the present invention, such a database may contain a table of available linguistic elements, a table of available talk topics, and a table of linguistic element categories. Each linguistic element, talk topic, and linguistic element category can be assigned a unique identifier for use within the database, thereby providing a layer of abstraction between the underlying linguistic element information and the relational information stored in the database. Each talk topic, linguistic element category, and/or linguistic element entry in the database may include a pointer, such as a Uniform Resource Locator (“URL”) or path, to one or more images or graphics to be displayed as the icon for that entry, along with a pointer to one or more media elements to be associated with that entry. Each table may also include a field for a word or phrase associated with each entry, wherein the word or phrase is displayed under the icon as the user interacts with the device. The tables may further contain a field for text to be used as the basis for text-to-speech synthesis. Although occasionally referred to herein as separate from the media elements for clarity, it should be apparent to one skilled in the art that the synthesized speech can be considered part of the media elements. Although the use of pointers to externally stored media elements is disclosed herein, it should be apparent to one skilled in the art that such information can be stored within the database, such as, without limitation, as binary large objects (“BLOBs”), without departing from the spirit or the scope of the invention. The database can also include a table representing the interrelationship of the various talk topics, linguistic element categories, and linguistic elements.

FIGS. 4 through 7 illustrate an exemplary language interface. In FIG. 4, the user can select from among a plurality of available talk topics 401-406. Such talk topics may include, but are not limited to, “New People” 401, “Group Talk” 402, “Family Talk” 403, “Comfort” 404, “Feelings” 405, and “Phone” 406. Each of these talk topics represents the top layer of a hierarchy of linguistic element categories and linguistic elements.

In a preferred embodiment, although the device or other user interface may only be able to concurrently display a limited number of user interface elements, such as the six-element display illustrated in FIG. 4, more than that number of talk topics, linguistic element categories, and/or linguistic elements may be available. To facilitate the rapid communication object of the present invention, it is presently preferred that the most frequently accessed talk topics be presented on a single screen. The user can navigate to the next most frequently accessed screen of talk topics, the previous screen of talk topics, or up a level in the hierarchy, using navigation buttons 106. The selection of the talk topics to be included in the primary screen can be made by the user, can be inferred based on the user's actual usage of the various talk topics, prescribed at the time the talk topic database is configured, or the like. Although the preceding navigation description focused on talk topics, it should be apparent to one skilled in the art that similar navigation techniques can be implemented for linguistic element categories, linguistic elements, fringe words, core words, and the like.

When the user selects a talk topic, the user is presented with a plurality of linguistic element categories such as linguistic element categories 501-506 illustrated in FIG. 5. These linguistic element categories preferably represent various communicative intents. In a preferred embodiment, the linguistic element categories are chosen such that they are relevant to, and can be associated with, all talk topics. In one embodiment, the available linguistic element categories include those corresponding to communicating about something the user wants to do, communicating about things or information, communicating something positive, communicating something negative, and asking a question.

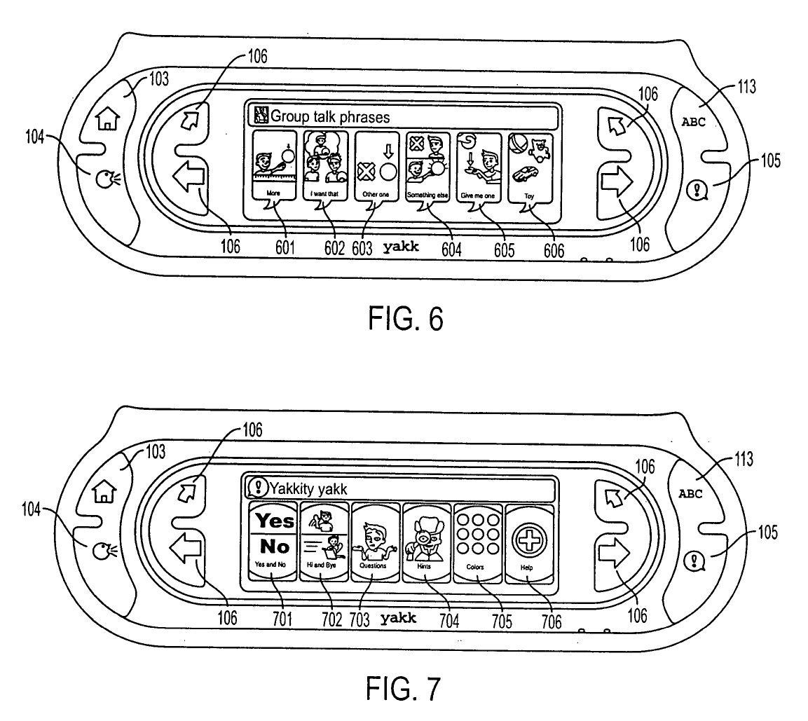

Although the linguistic element categories are preferably shared across talk topics, the linguistic elements associated with the linguistic element categories may vary between talk topics. When a user selects a linguistic element category from the available linguistic element categories, the user is preferably presented with a set of linguistic elements relevant to the selected talk topic and linguistic element category, such as linguistic elements 601-606 of FIG. 6.

As described above, an object of the present invention is to facilitate rapid communication. To that end, the linguistic element most frequently used within a given linguistic element category is positioned such that it is directly underneath, or in the same position within the user interface, as the selected linguistic element category. Thus, where the user has selected the group talk 402 talk topic of FIG. 4, and subsequently selected the linguistic element category corresponding to communicating about things or information, such as get that 502 of FIG. 5, the linguistic element located in position 602 of the user interface should correspond to the most frequently used linguistic element within that category. Similarly, the next most frequently used linguistic elements should be positioned to either side of the most frequently used linguistic element. This can help reduce the amount of physical movement necessary to select a linguistic element, and can thus allow for faster communication. Still further, while such an arrangement is preferred for the first screen of linguistic elements, the most frequently used linguistic element on the second screen should be positioned near the end of the screen, as the user has just pressed one of navigation buttons 106 and therefore the user's hand is closer to that position. In one embodiment, the end at which the most frequently used linguistic element appears on the second screen is determined based on which of navigation buttons 106 was pressed.

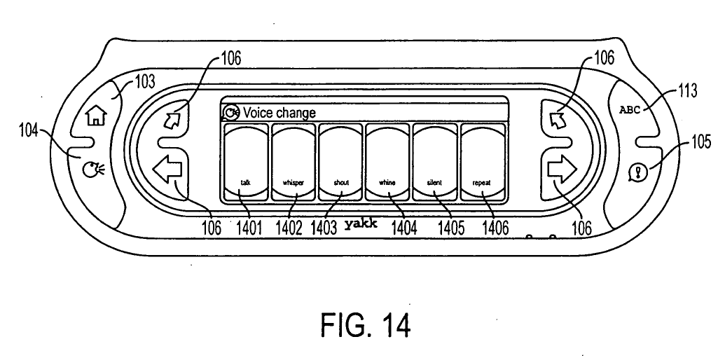

When the user selects a linguistic element, the linguistic element may be immediately communicated, or the linguistic element may be stored in a linguistic element buffer for subsequent communication. Where the selected linguistic element is stored in a buffer, the user may edit the buffer content prior to initiating communication of the stored linguistic elements. Such editing may include, but is not limited to, the imposition of an inflection on one or more of the stored linguistic elements, reordering the selected linguistic elements, and deleting a stored linguistic element. FIG. 14 illustrates a user interface through which the user can select from a plurality of inflections 1401-1406 to be applied to the linguistic element buffer, or to be applied to the next selected linguistic element. Such a user interface can preferably be accessed at any time by pressing voice change button 106.

Storing a plurality of linguistic elements in a language buffer allows the user to build complex sentences. The user can subsequently cause the one or more media elements associated with the plurality of linguistic elements stored in the language buffer to be sequentially presented to others, thereby creating a more natural communication environment. The media elements presented by the language interface can be output in a variety of forms. In one embodiment, the media element or elements may be transferred to an appropriate output device. In another embodiment, a pointer to the media element or elements may be passed to the output device. In still another embodiment, the media and/or multimedia content can be pre-processed by the interface for presentation by an output device. An example of this later embodiment includes the processing of digitized audio by one or more digital to analog converters for presentation by standard, analog speakers. It should be apparent to one skilled in the art that although the embodiments described above include one or more output devices as part of the language interface, additional and/or alternative output devices, including those external to the language interface, may be substituted therefor without departing from the spirit or the scope of the invention.

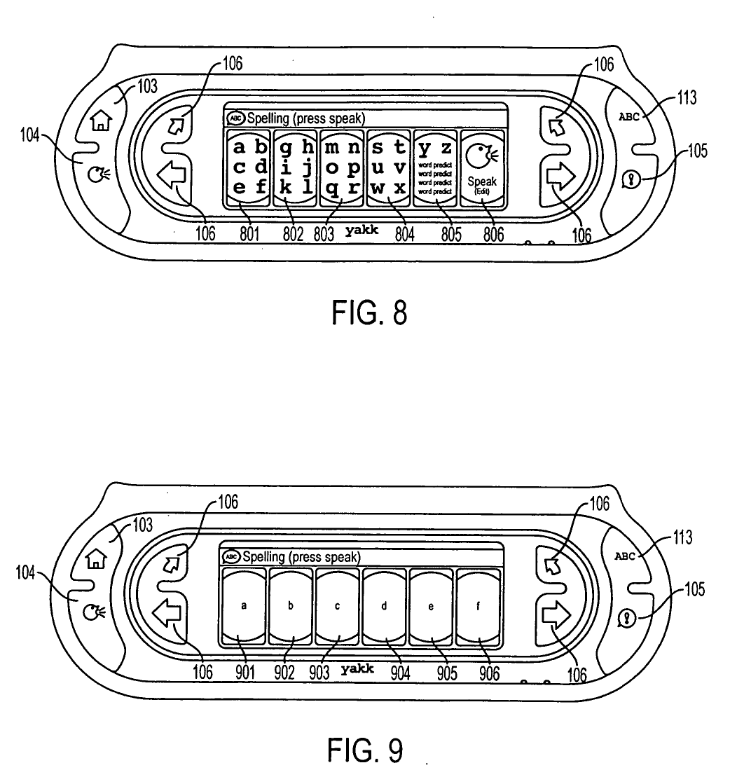

If the desired linguistic element is not available under the selected communicative intent, the user can navigate to another communicative intent and find the desired linguistic element, the user can spell out the desired linguistic element, or the user can select from a set of fringe words and/or core words. FIGS. 8 and 9 illustrate a user interface through which the user can access alphanumeric or other characters. In this embodiment, the alphanumeric or other characters are preferably divided into a plurality of groups, such as groups 801-805 of FIG. 8. The display then preferably changes to one similar to that of FIG. 9, wherein the user can select the appropriate character from the set of characters 901-906.

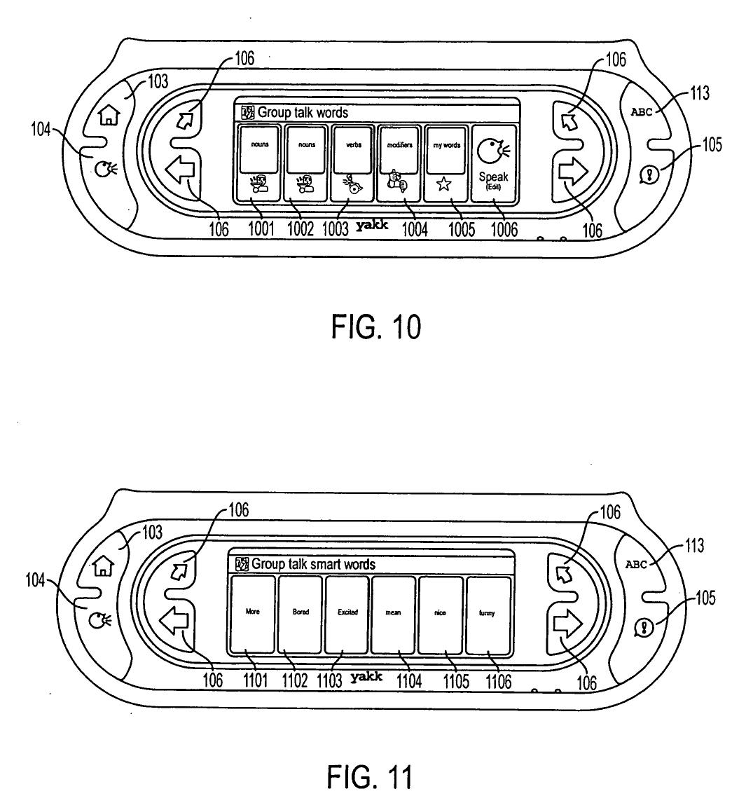

FIGS. 10 and 11 illustrate an interface through which fringe words can be accessed. Fringe words are words that are relevant to the chosen talk topic and linguistic element category, but are not used frequently enough to necessitate their inclusion on the main linguistic element screens. In the illustrated embodiment, the fringe words are accessed via navigation buttons 106, and are preferably available on the screen immediately following the set or sets of frequently used linguistic elements.

The fringe words can be divided into a plurality of categories 1001 through 1005. In a preferred embodiment, such categories include, but are not limited to, two sets of nouns (1001 and 1002), one set of verbs 1003, one set of modifiers 1004, and one set of user-specific words 1005. Speak button 1006 preferably allows the user to edit the linguistic elements associated with my words 1005.

When the user has selected a desired fringe word category, a user interface similar to that of FIG. 11 is preferably presented to the user. In the illustrated embodiment, the user is presented with the most frequently used fringe words 1101 through 1106. As with the linguistic element categories and linguistic elements, the most frequently used fringe word within each fringe word category is preferably positioned underneath the respective fringe word category on the first screen of fringe words. The next most frequently used fringe words are then positioned to either side of the most frequently used fringe word, where possible. Thus, in the embodiments illustrated in FIGS. 10 and 11, the user has chosen fringe word category “verbs” 1003, and fringe word “excited” 1103 represents the most frequently used verb within the current talk topic and fringe word. Additional fringe words can be accessed using navigation buttons 106. Again, as with the linguistic elements, the most frequently used fringe word on each subsequent fringe word screen is preferably positioned at or near the end of the screen, and the respective positions may alternate depending on the navigation button used to access the fringe word screen.

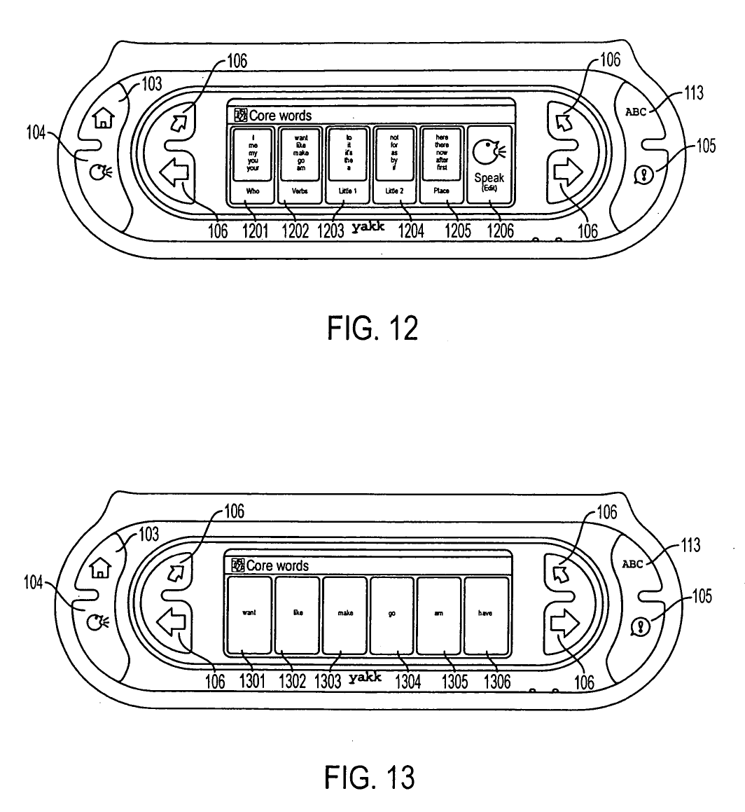

FIGS. 12 and 13 illustrate user interfaces through which the user can access core words. Core words are preferably a set of frequently used words that do not appear in the linguistic elements or fringe words associated with a given talk topic. By way of example, without intending to limit the present invention, the word “want” is frequently used in conversation, but may not be particularly relevant or occur with enough regularity in a given talk topic for it to appear as a linguistic element or fringe word.

Core words are structured in a manner similar to that of linguistic elements and fringe words, except that, where the set of fringe words typically varies based on talk topic, the set of core words is constant. The core words are preferably broken down into a plurality of categories, including subject-oriented words 1201, verbs 1202, short words 1203 and 1204, and place-specific words 1205. As with the linguistic elements and fringe words, the most frequently accessed core word within each core word category is preferably positioned under the respective category, and the next most frequently accessed core words are positioned on either side of the most frequently accessed core word, where possible.

The hierarchical structure containing a talk topic and its related linguistic element categories and linguistic elements is generally referred to as a “smart set”. FIG. 3 illustrates an alternative embodiment of the apparatus, wherein the apparatus is in customization mode. In this mode, the user can define one or more custom smart sets to be used in place of standard smart sets that ship with or are purchased as add-ons to the language interface. In still another embodiment, the user can define his or her own smart sets and add one or more new linguistic elements to a smart set, in customization mode.

While a user interface employing a single row of user interface elements is described herein, it should be apparent to one skilled in the art that alternative user interfaces may be substituted therefor without departing from the spirit or the scope of the invention. By way of example, without intending to limit the present invention, a screen capable of concurrently displaying thirty-six user interface elements arranged in a six column by six row grid may be used. In such an embodiment, the user can be presented with thirty-six talk topics, and, upon selection of a talk topic, the six most frequently used linguistic elements corresponding to six linguistic element categories can be used to fill the display. For example, each row may contain linguistic elements corresponding to a specific linguistic element category. In such an embodiment, the first cell of each row or column may alternatively contain a user interface element corresponding to the linguistic element category, and upon activation of such an element by the user, additional linguistic elements are substituted for those currently appearing in the row.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of organizing linguistic elements, comprising:
creating a plurality of talk topics, wherein each talk topic relates to a particular subject;
defining a first set of linguistic element categories, each of the linguistic element categories representing a communicative intent;
providing an association between the first set of linguistic element categories and a first one of the plurality of talk topics;
providing an association between a first plurality of linguistic elements and one of the first set of linguistic element categories;
defining a second set of linguistic element categories, each of the linguistic element categories representing a communicative intent;
providing an association between the second set of linguistic element categories and a second one of the plurality of talk topics; and
providing an association between a second plurality of linguistic elements and the second set of linguistic element categories.

2. The method of claim 1, wherein the communicative intent represented by each of the first set of linguistic element categories and each of the second set of linguistic element categories are identical.

3. The method of claim 2, wherein the association provided between the first plurality of linguistic elements and the first linguistic element category is based on the talk topic with which the linguistic element category is associated.

4. The method of claim 1, wherein the first linguistic element category set comprises:
at least one linguistic element category corresponding to communicating about something the user wants or does not want to do;
at least one linguistic element category corresponding to communicating about things or information;
at least one linguistic element category corresponding to communicating something positive;
at least one linguistic element category corresponding to communicating something negative; and
at least one linguistic element category corresponding to asking a question.

5. The method of claim 4, wherein the first linguistic element category set is further comprised of at least one linguistic element category corresponding to communicating a story.

6. The method of claim 4, wherein the first linguistic element category set is further comprised of at least one linguistic element category corresponding to communicating an instruction.

7. The method of claim 1, wherein at least one of the first linguistic element category set and the second linguistic element category set is comprised of:
at least one linguistic element category corresponding to communicating about something the user wants or does not want to do;
at least one linguistic element category corresponding to communicating about things or information;
at least one linguistic element category corresponding to communicating something positive;
at least one linguistic element category corresponding to communicating something negative; and
at least one linguistic element category corresponding to asking a question.

8. The method of claim 7, wherein at least one of the first linguistic element category set and the second linguistic element category set is further comprised of at least one linguistic element category corresponding to communicating a story.

9. The method of claim 7 wherein at least one of the first linguistic element category set and the second linguistic element category set is further comprised of at least one linguistic element category corresponding to communicating an instruction.

10. The method of claim 1, wherein the first talk topic is additionally associated with a third set of linguistic element categories.

11. The method of claim 1, wherein the first plurality of linguistic elements and the second plurality of linguistic elements comprise no common linguistic elements.

12. The method of claim 1, further comprising:
defining a language buffer;
receiving from a user a selected linguistic element; and,
storing the selected linguistic element in the language buffer.

13. The method of claim 12, further comprising allowing the user to reorder the linguistic elements stored in the language buffer.

14. The method of claim 12, further comprising allowing the user to delete a linguistic element from the language buffer.

15. The method of claim 12, further comprising allowing the linguistic elements stored in the language buffer to be sequentially communicated.

16. The method of claim 15, wherein the linguistic elements stored in the language buffer are communicated via an E-mail.

17. The method of claim 15, wherein the linguistic elements stored in the language buffer are communicated via an instant message.

18. The method of claim 15, wherein the linguistic elements stored in the language buffer are communicated by playing at least one audio file associated with each linguistic element.

19. The method of claim 15, wherein the linguistic elements stored in the language buffer are communicated by allowing a computer to synthesize human speech for each linguistic element.

20. A method of organizing linguistic elements, comprising:
creating a plurality of talk topics, wherein each talk topic relates to a particular subject;
defining a first set of linguistic element categories, each of the linguistic element categories representing a communicative intent;
providing an association between the first set of linguistic element categories and a first one of the plurality of talk topics; and
providing an association between a first plurality of linguistic elements and one of the first set of linguistic element categories.

21. The method of claim 20, further comprising:
defining a second plurality of linguistic elements,
providing an association between the second plurality of linguistic elements and the first set of linguistic element categories; and,
providing an association between the second plurality of linguistic elements and a second one of the plurality of talk topics.

22. The method of claim 21, wherein the first plurality of linguistic elements and the second plurality of linguistic elements comprise no common linguistic elements.

23. The method of claim 20, wherein the first talk topic is additionally associated with a second set of linguistic element categories.

24. A method of organizing linguistic elements, comprising:
creating a plurality of talk topics, wherein each talk topic relates to a subject;
associating a plurality of linguistic elements with each of the plurality of talk topics, wherein the linguistic elements associated with each talk topic are related to the communicative needs of the associated talk topic; and,
organizing the plurality of linguistic elements into linguistic element categories, wherein each of the plurality of linguistic element categories represents a communicative intent.

25. The method of claim 24, wherein the same set of linguistic element categories is used in each talk topic.

26. The method of claim 24, wherein the linguistic element categories comprise:
at least one linguistic element category corresponding to communicating about something the user wants or does not want to do;
at least one linguistic element category corresponding to communicating about things or information;
at least one linguistic element category corresponding to communicating something positive;
at least one linguistic element category corresponding to communicating something negative; and
at least one linguistic element category corresponding to asking a question.

27. The method of claim 24, wherein the linguistic element categories further comprise at least one linguistic element category corresponding to communicating a story.

28. The method of claim 24, wherein the linguistic element categories further comprise at least one linguistic element category corresponding to communicating an instruction.

29. The method of claim 24, further comprising defining at least one set of fringe linguistic elements.

30. The method of claim 29, wherein a set of fringe linguistic elements is associated with a plurality of talk topics.

31. The method of claim 30, wherein the fringe linguistic elements are categorized based on parts of speech.

32. The method of claim 31, wherein the parts of speech categories include nouns, verbs, and modifiers.

33. The method of claim 32, wherein the parts of speech categories further include a category for user-specific linguistic elements.

34. The method of claim 30, further comprising defining a set of core words.

35. The method of claim 24, further comprising:
defining a language buffer;
receiving from a user a selected linguistic element; and,
storing the selected linguistic element in the language buffer.

36. The method of claim 35, further comprising allowing the user to reorder the linguistic elements stored in the language buffer;

37. The method of claim 35, further comprising allowing the user to delete a linguistic element from the language buffer.

38. The method of claim 35, further comprising allowing the linguistic elements stored in the language buffer to be sequentially presented.

39. A method of organizing linguistic elements for display in a user interface, comprising:
defining a maximum number of user interface elements to be concurrently displayed in a user interface;
defining a set of talk topics, wherein each talk topic relates to a particular subject;
associating a plurality of linguistic elements with each of the plurality of talk topics, wherein the linguistic elements associated with each talk topic are related to the subject of the associated talk topic;
defining a set of linguistic element categories, wherein each of the plurality of linguistic element categories represents a communicative intent;
assigning each of the linguistic element categories a display position in the user interface;
associating at least one linguistic element with at least one linguistic element category; and,
ordering the linguistic elements associated with each linguistic element category such that the most frequently used linguistic element within each linguistic element category is in the same display position in the user interface as the linguistic element category with which it is associated.

40. The method of claim 39, wherein the user interface elements are presented in a linear array.

41. The method of claim 39, further comprising permitting the linguistic elements within each linguistic element category to be reordered.

42. The method of claim 41, wherein the reordering is based on the frequency of use anticipated by the user.

43. The method of claim 41, wherein the reordering is based on user input.

44. The method of claim 41, further comprising monitoring the frequency with which a user accesses each linguistic element and reordering the linguistic elements within each linguistic element category based on frequency of use.

45. The method of claim 41, wherein the reordering places the most frequently used linguistic element in the same position as the linguistic element category with which it is associated.

46. The method of claim 39, wherein the second most frequent linguistic element immediately adjacent to the most frequently used linguistic element.

47. The method of claim 46, wherein the organizing step is comprised of placing the third most frequently used linguistic element immediately adjacent to the most frequently used linguistic element if that space is available.

48. The method of claim 39, wherein the number of linguistic element categories is equal to the maximum number of user interface elements to be displayed at a time.

49. The method of claim 39, wherein the number of linguistic element categories is equal to an integer multiple of the maximum number of user interface elements to be displayed at a time.

50. A method of communicating, comprising:
selecting a talk topic from a plurality of available talk topics, wherein each talk topic is associated with a set of linguistic element categories;
selecting a linguistic element category from the set of linguistic element categories associated with the selected talk topic, wherein each linguistic element category represents a communicative intent and is associated with a set of linguistic elements;
selecting a linguistic element from the set of linguistic elements associated with the selected linguistic element category; and,
communicating the selected linguistic element.

51. The method of claim 50, further comprising storing the selected linguistic element in a language buffer.

52. The method of claim 51, further comprising allowing the stored linguistic elements to be edited.

53. The method of claim 52, wherein the editing includes reordering the stored linguistic elements within the language buffer.

54. The method of claim 52, wherein the communicating step is comprised of sequentially iterating through the stored linguistic elements.

55. The method of claim 51, wherein the communicating step is comprised of sequentially iterating through the stored linguistic elements.

56. The method of claim 50, wherein the same set of linguistic element categories is used for each talk topic.

57. The method of claim 50, wherein the set of linguistic elements associated with each linguistic element category varies based on the talk topic with which the linguistic element category is associated.

58. The method of claim 50, wherein the set of linguistic element categories includes a story category.

59. The method of claim 50, wherein the linguistic elements associated with the story category are associated with a set of instructions.

60. The method of claim 50, wherein the set of linguistic element categories comprises both communicative intent based categories and part of speech categories.

61. The method of claim 60, wherein the part of speech categories comprise nouns, verbs, and modifiers.

62. The method of claim 50, wherein the linguistic elements are ordered within each linguistic element category such that the most frequently used linguistic element within each linguistic element category is in the same position as the linguistic element category.

63. The method of claim 50, further comprising repeating the method beginning with the linguistic element category selection step after the communicating step has been initiated.

64. The method of claim 51, further comprising repeating the method beginning with the linguistic element category selection step after the communicating step has completed.

65. The method of claim 51, further comprising repeating the method beginning with the linguistic element category selection step after the communicating step has been initiated.

66. The method of claim 51, further comprising repeating the method beginning with the linguistic element category selection step after the communicating step has completed.
